(19) United States
(12) Patent Application Publication
(10) Pub. No.: US 2023/0046428 A1
(43) Pub. Date: Feb. 16, 2023

(54) Electric Toothbrush Device

(71) Applicant: Jon Welsh, Liberty, MO (US)

(72) Inventor: Jon Welsh, Liberty, MO (US)

(21) Appl. No.: 17/400,874

(22) Filed: Aug. 12, 2021

(51) Int. Cl. A61C 17/22; A61C 17/34

(52) U.S. Cl. CPC A61C 17/224; A61C 17/221; A61C 17/3472; A46B 2200/1066; A61C 17/3427; A61C 17/3481

(57) ABSTRACT

An electric toothbrush device having bristle movement in three dimensions includes an elongate body comprising a neck extending between a handle and a head. A drive shaft engaged to a motor in the handle extends into the head. A plate is engaged to a transfer shaft, which extends perpendicularly from the drive shaft through a planar face of the head and which is operationally engaged to the drive shaft. The plate is external to the head and parallel to the planar face. Bristles are engaged to a second face of the plate. First and second protuberances are engaged to the planar face and the plate, respectively. Movement of the plate parallel to the planar face induced by the transfer shaft brings the second protuberance into contact with the first protuberance to induce repetitive movement of the plate and the bristles in a direction perpendicular to the planar face.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to toothbrush devices and more particularly pertains to a new toothbrush device having bristle movement in three dimensions. The present invention discloses a new toothbrush device comprising an electronic toothbrush capable of moving bristles of a brush head in two perpendicular planes.

### Description of Related Art Including Information Disclosed Under 37 CFR 1.97 And 1.98.

The prior art relates to toothbrush devices, and in particular electronic toothbrushes. Prior art electronic toothbrushes provide a variety of means for moving a brush head and attached bristles in a single plane. What is lacking in the prior art is an electronic toothbrush capable of moving the bristles in two perpendicular planes.

### BRIEF SUMMARY OF THE INVENTION

An embodiment of the disclosure meets the needs presented above by generally comprising an elongate body, which in turn comprises a neck extending between a handle and a head. The elongate body defines an interior space. A motor is engaged to the handle and is positioned in the interior space. A drive shaft is engaged to the motor and extends through the neck into the head. A transfer shaft is operationally engaged to the drive shaft and extends substantially perpendicularly from the drive shaft through a planar face of the head. A plate is engaged by a first face to the transfer shaft. The plate is external to the head and the first face is parallel to the planar face. The transfer shaft is positioned to translate movement of the drive shaft to the plate to move the plate parallel to the planar face. A plurality of bristles is engaged to and extends from a second face of the plate.

A first protuberance is engaged to and extends from the planar face of the head. A second protuberance is engaged to and extends from the first face of the plate. Movement of the plate parallel to the planar face brings the second protuberance into contact with the first protuberance to induce repetitive movement of the plate and the bristles in a direction substantially perpendicular to the planar face.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of an electric toothbrush device according to an embodiment of the disclosure.

FIG. 2 is a side view of an embodiment of the disclosure.

FIG. 3 is a side view of an embodiment of the disclosure.

FIG. 4 is a cross-sectional view of an embodiment of the disclosure.

FIG. 5 is a cross-sectional view of an embodiment of the disclosure.

FIG. 6 is an exploded view of an embodiment of the disclosure.

### DETAILED DESCRIPTION OF THE INVENTION

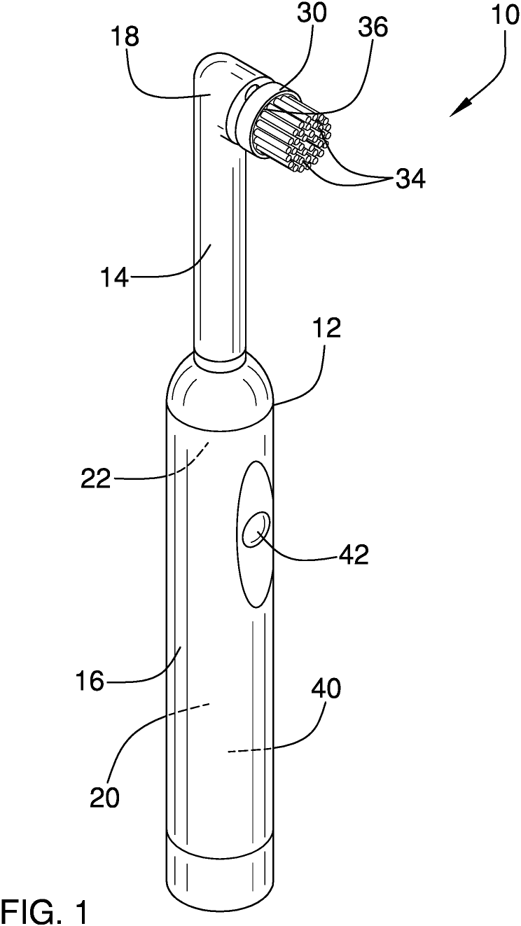

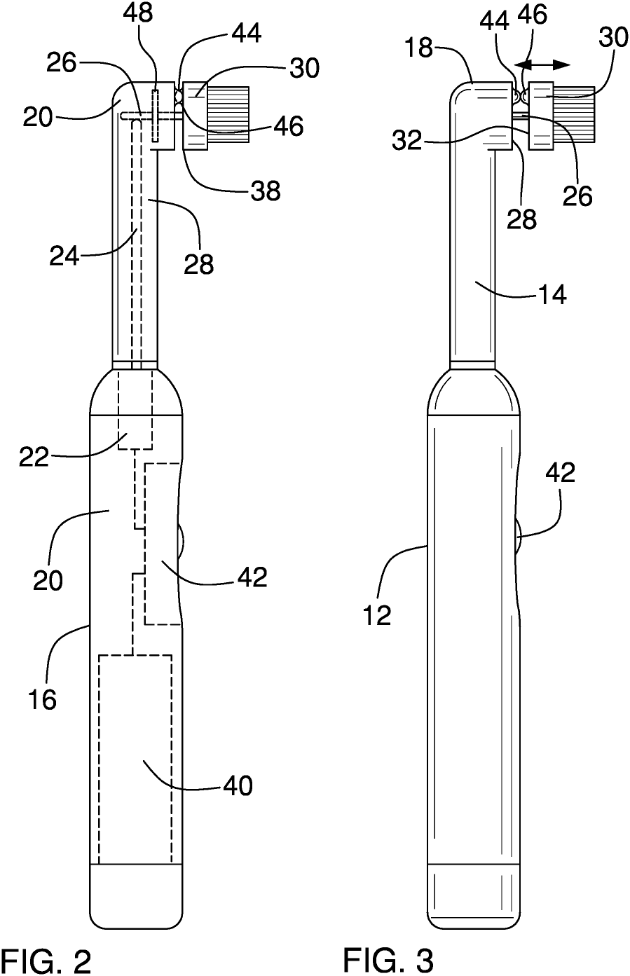

With reference now to the drawings, and in particular to FIGS. 1 through 6 thereof, a new toothbrush device embodying the principles and concepts of an embodiment of the disclosure and generally designated by the reference numeral 10 will be described.

As best illustrated in FIGS. 1 through 6, the electric toothbrush device 10 generally comprises an elongate body 12, which in turn comprises a neck 14 extending between a handle 16 and a head 18. The elongate body 12 defines an interior space 20. A motor 22 is engaged to the handle 16 and is positioned in the interior space 20. A drive shaft 24 is engaged to the motor 22 and extends through the neck 14 into the head 18. A transfer shaft 26 is operationally engaged to the drive shaft 24 and extends substantially perpendicularly from the drive shaft 24 through a planar face 28 of the head 18.

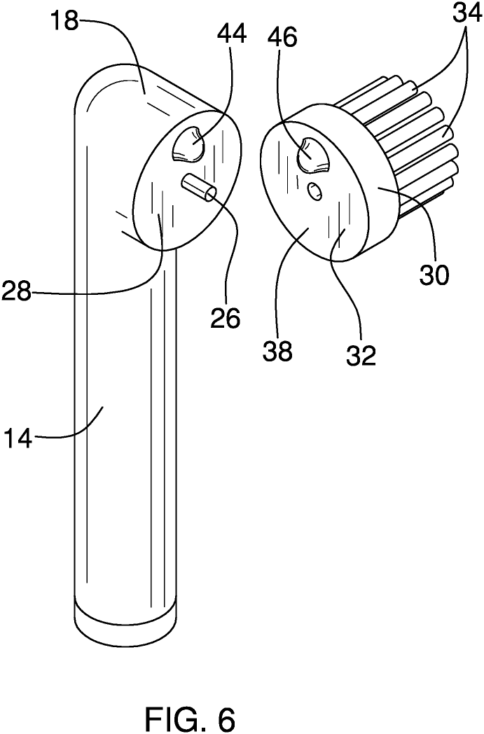

A plate 30 is engaged by a first face 32 to the transfer shaft 26. The plate 30 is external to the head 18. The first face 32 is parallel to the planar face 28. A plurality of bristles 34 is engaged to and extends from a second face 36 of the plate 30. The first face 32 may be substantially circularly shaped, substantially rectangularly shaped, substantially triangularly shaped, substantially ovally shaped, substantially elongated ovally shaped, or the like. As shown in FIG. 6, the neck 14 may be detachable from the handle 16, with the head 18 and plate 30 being integral to the neck 14. The neck 14 being detachable is a configuration well known to those skilled in the art of electronic toothbrushes.

The transfer shaft 26 is positioned to translate movement of the drive shaft 24 to the plate 30 to move the plate 30 parallel to the planar face 28, which should be interpreted to mean the plate 30 being in motion, but movement occurring substantially in a plane 38 parallel to the planar face 28. This is the type of motion seen in prior art devices. The motor 22, the drive shaft 24, and the transfer shaft 26 may be configured to impart rotation oscillation, circular rotation, counter oscillation, or side to side vibration to the plate 30. Particular configurations of the motor 22, the drive shaft 24, and the transfer shaft 26 intended to impart associated movement of the plate 30 are known to those skilled in the art of electric toothbrushes.

A battery 40 is engaged to the handle 16, positioned in the interior space 20, and is operationally engaged to the motor 22. The battery 40 is positioned to selectively power the motor 22. The battery 40 may be rechargeable, although the present invention also anticipates the battery 40 being replaceable.

A switch 42 is engaged to the handle 16 and is operationally engaged to the battery 40 and the motor 22. The switch 42 is configured to be selectively switched to operationally engage the motor 22 to the battery 40. Switching means for electronic toothbrushes are well known to those skilled in the art of electronic toothbrushes, and also may comprise timers, speed selectors, motion selectors, and the like.

A first protuberance 44 is engaged to and extends from the planar face 28 of the head 18. A second protuberance 46 is engaged to and extends from the first face 32 of the plate 30. Movement of the plate 30 the plane 38 parallel to the planar face 28 brings the second protuberance 46 into contact with the first protuberance 44 to induce repetitive movement of the plate 30 and the bristles 34 in a direction substantially perpendicular to the planar face 28.

The second protuberance 46 and the first protuberance 44 may be substantially hemispherically shaped, as shown in FIG. 6. The present invention anticipates the first protuberance 44 and the second protuberance 46 having a wide variety of configurations. For example, multiple first protuberances 44 and/or multiple second protuberances 46 may be utilized. Additionally first protuberances 44 and second protuberances 46 that are not hemispherically shaped could be used, such as, but not limited to, tooth shaped, ridge shaped, and the like.

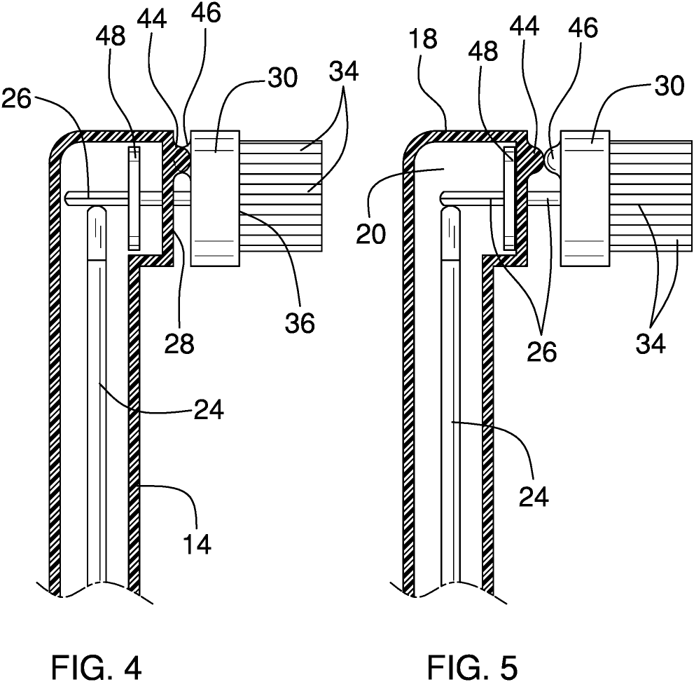

A ring 48 may engaged to the transfer shaft 26 and is positioned in the interior space 20 proximate to the planar face 28. The ring 48 is positioned to limit a range of motion of the transfer shaft 26 perpendicular to the planar face 28, as shown in FIGS. 4 and 5.

In use, the electronic toothbrush device 10 is utilized by a user to brush their teeth. The first protuberance 44 and the second protuberance 46 induce movement of the bristles 34 perpendicular to the planar face 28 of the head 18 to provide enhance cleaning of the user’s teeth, in particular hard to reach areas such as pockets.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electric toothbrush device comprising:
an elongate body comprising a neck extending between a handle and a head, the elongate body defining an interior space;
a motor engaged to the handle and positioned in the interior space;
a drive shaft engaged to the motor and extending through the neck into the head;
a transfer shaft operationally engaged to the drive shaft and extending substantially perpendicularly from the drive shaft through a planar face of the head;
a plate engaged by a first face to the transfer shaft, such that the plate is external to the head and the first face is parallel to the planar face, such that the transfer shaft is positioned for translating movement of the drive shaft to the plate for moving the plate parallel to the planar face;
a plurality of bristles engaged to and extending from a second face of the plate;
a first protuberance engaged to and extending from the planar face of the head; and
a second protuberance engaged to and extending from the first face of the plate, such that movement of the plate parallel to the planar face brings the second protuberance into contact with the first protuberance for inducing repetitive movement of the plate and the bristles substantially perpendicular to the planar face.

2. The electric toothbrush device of claim 1, further including a battery engaged to the handle and positioned in the interior space, the battery being operationally engaged to the motor, such that the battery is positioned for selectively powering the motor.

3. The electric toothbrush device of claim 2, wherein the battery is rechargeable.

4. The electric toothbrush device of claim 2, further including a switch engaged to the handle and being operationally engaged to the battery and the motor, wherein the switch is configured for selectively switching for operationally engaging the motor to the battery.

5. The electric toothbrush device of claim 1, wherein the motor, the drive shaft, and the transfer shaft are configured for imparting rotation oscillation, circular rotation, counter oscillation, or side to side vibration to the plate.

6. The electric toothbrush device of claim 1, wherein the first face is substantially circularly shaped, substantially rectangularly shaped, substantially triangularly shaped, substantially ovally shaped, or substantially elongated ovally shaped.

7. The electric toothbrush device of claim 1, wherein the second protuberance and the first protuberance are substantially hemispherically shaped.

8. The electric toothbrush device of claim 1, further including a ring engaged to the transfer shaft and being positioned in the interior space proximate to the planar face, such that the ring is positioned for limiting a range of motion of the transfer shaft perpendicular to the planar face.

9. An electric toothbrush device comprising:
an elongate body comprising a neck extending between a handle and a head, the elongate body defining an interior space;
a motor engaged to the handle and positioned in the interior space;
a battery engaged to the handle and positioned in the interior space, the battery being operationally engaged to the motor, such that the battery is positioned for selectively powering the motor, the battery being
rechargeable;
a switch engaged to the handle and being operationally engaged to the battery and the motor, wherein the switch is configured for selectively switching for operationally engaging the motor to the battery;
a drive shaft engaged to the motor and extending through the neck into the head;
a transfer shaft operationally engaged to the drive shaft and extending substantially perpendicularly from the drive shaft through a planar face of the head;
a plate engaged by a first face to the transfer shaft, such that the plate is external to the head and the first face is parallel to the planar face, such that the transfer shaft is positioned for translating movement of the drive shaft to the plate for moving the plate parallel to the planar face, the motor, the drive shaft, and the transfer shaft being configured for imparting rotation oscillation, circular rotation, counter oscillation, or side to side vibration to the plate, the first face being substantially circularly shaped, substantially rectangularly shaped, substantially triangularly shaped, substantially ovally shaped, or substantially elongated ovally shaped;
a plurality of bristles engaged to and extending from a second face of the plate;
a first protuberance engaged to and extending from the planar face of the head;
a second protuberance engaged to and extending from the first face of the plate, such that movement of the plate parallel to the planar face brings the second protuberance into contact with the first protuberance for inducing repetitive movement of the plate and the bristles substantially perpendicular to the planar face, the second protuberance and the first protuberance being substantially hemispherically shaped; and
a ring engaged to the transfer shaft and being positioned in the interior space proximate to the planar face, such that the ring is positioned for limiting a range of motion of the transfer shaft perpendicular to the planar face.
